(19) United States
(12) Patent Application Publication
(10) Pub. No.: US 2022/0134632 A1
(43) Pub. Date: May 5, 2022

(54) STACKED WORKPIECE MOLDING METHOD AND DEVICE FOR SAME

(71) Applicant: HONDA MOTOR CO., LTD., Tokyo (JP)

(72) Inventors: Akira Taguchi, Tochigi (JP); Hiroaki Iwanishi, Tochigi (JP); Michinobu Sato, Tochigi (JP); Hikaru Kurokawa, Tochigi (JP); Takashi Iino, Tochigi (JP); Yusuke Kato, Tochigi (JP); Takashi Abe, Tochigi (JP)

(21) Appl. No.: 17/424,711

(22) PCT Filed: Oct. 30, 2019
(86) PCT No.: PCT/JP2019/042645

§ 371 Date: Jul. 21, 2021

(30) Foreign Application Priority Data
Jan. 23, 2019 (JP) 2019-009246

(51) Int. Cl. B29C 51/12; B29C 51/10; B29C 51/36; B29C 33/18

(52) U.S. Cl. CPC B29C 51/12; B29C 33/18; B29C 51/36; B29C 51/10

(57) ABSTRACT

In a stacked workpiece molding method, a second mold 30 includes through-holes 32 that extend to be opened at a peripheral edge of a workpiece body 42, the through-holes 32 are connected to a first suction device 51 that sucks a sheet material 44, a first mold 20 includes suction holes 22 that extend to be opened at a portion that contacts the workpiece body 42, the suction holes 22 are connected to a second suction device 52 that sucks the workpiece body 42, and in a bonding step of bonding the sheet material 44 to the workpiece body 42, a suction force in the through-holes 32 by the first suction device 51 is set stronger than a suction force in the suction holes 22 by the second suction device 52.

### TECHNICAL FIELD

The present invention relates to a stacked workpiece molding method and a device for the same.

### BACKGROUND ART

Conventionally, there has been known a stacked workpiece molding device that molds a stacked workpiece including a workpiece body and a sheet material stacked on the workpiece body by using a first mold for sucking and holding the workpiece body (see, for example, JP H07-24909 A).

In Patent Literature 1, in order to prevent the sheet material from being drawn into a clearance recess formed in a central portion of the workpiece body and being torn, the clearance recess is closed by a shutter.

Further, since the degree of freedom in layout of the workpiece body is restricted when the shutter covering the clearance recess is provided, there is also known what is provided with a suction device that is positioned in the clearance recess formed in the central portion of the workpiece body and sucks the sheet material in a direction away from the workpiece body (see, for example, JP 2000-218688 A).

### CITATION LIST

### Patent Literature

Patent Literature 1: JPH07-24909 A

Patent Literature 2: JP 2000-218688 A

### SUMMARY OF INVENTION

### Technical Problem

In the stacked workpiece molding device of Patent Literature 1, in cases where a second mold having on an inner surface a pattern that can be transferred to the surface of the sheet material is used, when the sheet material is sucked by the second mold and the pattern is transferred and then the sheet material is stuck to the workpiece body such that the first mold, which sucks the workpiece body, overlaps with the second mold, it is conceivable to cause a fluid such as air to be ejected from the second mold in order to facilitate separation of the sheet material from the second mold.

In this case, the suction device that is positioned in the clearance recess formed in the central portion of the workpiece body and sucks the sheet material in a direction away from the workpiece body as in Patent Literature 1 cannot be provided. Therefore, in order to improve the degree of freedom in layout of the workpiece body, it is conceivable to arrange an insert in the clearance recess.

Further, it is conceivable to provide a shutter device at a peripheral edge of the workpiece body that does not affect the degree of freedom in layout of the workpiece body to prevent the sheet material from sticking to a place where the sheet material is not to be stuck at the peripheral edge of the workpiece body.

However, when the shutter device is provided at the peripheral edge of the workpiece body, there is a problem that since the sheet material is gripped by a clamp arranged outside the shutter device, it is necessary to prepare a sheet material that is large because of the shutter device, and the manufacturing cost of the stacked workpiece cannot be suppressed.

Further, since the shutter device has a complicated structure, and the shutter device needs to be installed in a plurality of places, the mold manufacturing cost cannot be suppressed, and further the maintenance of the shutter device requires labor and the maintainability is low.

In view of the above, it is an object of the present invention to provide a stacked workpiece molding method and a stacked workpiece molding device that can suppress the manufacturing costs of the stacked workpiece and the mold and improve the maintainability.

### Solution to Problem

[1] In order to achieve the above object, a stacked workpiece molding method of the present invention is a stacked workpiece molding method for molding a stacked workpiece by bonding a sheet material to a workpiece body using a stacked workpiece molding device including:

a first mold configured to suck and hold the workpiece body; and

a second mold configured to have on an inner surface a pattern that can be transferred to a surface of the sheet material stacked on the workpiece body and press the sheet material against the workpiece body;

the method including:

a transfer step of causing the sheet material to be stuck to the second mold and transferring the pattern onto the sheet material, in which

the second mold includes a through-hole that extends to be opened and positioned at a peripheral edge of the workpiece body,

the through-hole is connected to a first suction device that sucks the sheet material,

the first mold includes a suction hole that extends to be opened at a portion that contacts the workpiece body,

the suction hole is connected to a second suction device that sucks the workpiece body, and

in a bonding step of bonding the sheet material to the workpiece body, a suction force in the through-hole by the first suction device is set stronger than a suction force in the suction hole by the second suction device.

According to the present invention, since the sheet material at the peripheral edge of the workpiece body is sucked by the first suction device, it is not necessary to arrange the shutter device at the peripheral edge of the workpiece body. Thus, the stacked workpiece molding method can be provided in which the stacked workpiece can be molded using a sheet material that is small because the shutter device can be omitted and the manufacturing cost of the stacked workpiece can be suppressed. Further, since the structure of the mold can be simplified as compared with the case where the shutter device is provided, the mold manufacturing cost can be suppressed, and the maintainability can also be improved.

[2] Further, in the present invention, it is preferable that the second mold includes an ejection hole that extends to be positioned at a central portion of the workpiece body,

the ejection hole is connected to a gas supply device that supplies a gas to detach the sheet material from the inner surface of the second mold,

one mold of the first mold and the second mold includes a mold-side projection that projects toward the other mold so as to surround the through-hole, and

in the bonding step of bonding the sheet material to the workpiece body, the gas is supplied from the gas supply device to the surface of the sheet material through the ejection hole to separate the sheet material from the second mold at the central portion of the workpiece body.

When the sheet material is separated from the second mold by supplying the gas to the surface of the sheet material from the gas supply device through the ejection hole in the bonding step, when the gas supplied to the surface of the sheet material flows directly into the through-hole and is sucked by the first suction device, the sheet material suction performance by the first suction device deteriorates.

Therefore, when the mold-side projection is provided so as to surround the through-hole as described above, it is possible to suppress or prevent the gas supplied from the gas supply device to the surface of the sheet material from flowing into the through-hole, and it is possible to suppress or prevent the deterioration of the sheet material suction performance by the first suction device.

[3] Further, in the present invention, it is preferable that the mold-side projection is provided on the first mold. According to the present invention, since the mold-side projection is provided on the first mold, but not provided on the second mold, it is possible to prevent the pattern of the inner surface of the second mold from being not appropriately transferred to the sheet material by the mold-side projection.

[4] Further, the stacked workpiece molding device of the present invention is a stacked workpiece molding device including:

a first mold configured to suck and hold a workpiece body; and

a second mold configured to have on an inner surface a pattern that can be transferred to a surface of a sheet material stacked on the workpiece body and press the sheet material against the workpiece body, in which

the second mold includes a through-hole that extends to be opened and positioned at a peripheral edge of the workpiece body,

the through-hole is connected to a first suction device that sucks the sheet material,

the first mold includes a suction hole for sucking the workpiece body,

the suction hole is connected to a second suction device, and

the stacked workpiece molding device includes a control unit that sets suction forces of the first suction device and the second suction device.

According to the present invention, since the sheet material at the peripheral edge of the workpiece body is sucked by the first suction device, it is not necessary to arrange the shutter device at the peripheral edge of the workpiece body. Thus, the stacked workpiece molding device can be provided in which the stacked workpiece can be molded using a sheet material that is small because the shutter device can be omitted and the manufacturing cost of the stacked workpiece can be suppressed. Further, since the structure of the mold can be simplified as compared with the case where the shutter device is provided, the mold manufacturing cost can be suppressed, and the maintainability can also be improved.

[5] Further, in the stacked workpiece molding device of the present invention, it is preferable that the control unit sets the suction force in the through-hole by the first suction device to be stronger than the suction force in the suction hole by the second suction device in a bonding step of bonding the sheet material to the workpiece body.

According to the present invention, since the sheet material at the peripheral edge of the workpiece body is sucked by the first suction device, it is not necessary to arrange the shutter device at the peripheral edge of the workpiece body. Thus, the stacked workpiece molding device can be provided in which the stacked workpiece can be molded using a sheet material that is small because the shutter device can be omitted and the manufacturing cost of the stacked workpiece can be suppressed. Further, since the structure of the mold can be simplified as compared with the case where the shutter device is provided, the mold manufacturing cost can be suppressed, and the maintainability can also be improved.

[6, 7] Further, in the present invention, it is preferable that the second mold includes an ejection hole that extends to be positioned at a central portion of the workpiece body,

the ejection hole is connected to a gas supply device that supplies gas to detach the sheet material from the inner surface of the second mold,

one mold of the first mold and the second mold includes a mold-side projection that projects toward the other mold so as to surround the through-hole, and

the control unit, in the bonding step of bonding the sheet material to the workpiece body, supplies the gas from the gas supply device to the surface of the sheet material through the ejection hole to separate the sheet material from the second mold at the central portion of the workpiece body.

When the sheet material is separated from the second mold by supplying the gas to the surface of the sheet material from the gas supply device through the ejection hole in the bonding step, when the gas supplied to the surface of the sheet material flows directly into the through-hole and is sucked by the first suction device, the sheet material suction performance by the first suction device deteriorates.

Therefore, when the mold-side projection is provided so as to surround the through-hole as described above, it is possible to suppress or prevent the gas supplied from the gas supply device to the surface of the sheet material from flowing into the through-hole, and it is possible to suppress or prevent the deterioration of the sheet material suction performance by the first suction device.

[8, 9] Further, in the present invention, it is preferable that the mold-side projection is provided on the first mold. According to the present invention, since the mold-side projection is provided on the first mold, but not provided on the second mold, it is possible to prevent the pattern of the inner surface of the second mold from being not appropriately transferred to the sheet material by the mold-side projection.

### BRIEF DESCRIPTION OF DRAWINGS

FIG. 1 is an explanatory view schematically illustrating an embodiment of a stacked workpiece molding device of the present invention.

FIG. 2 is an explanatory view illustrating a first mold and a workpiece body of the present embodiment.

FIG. 3 is an enlarged explanatory view illustrating a through-hole of the present embodiment.

FIG. 4 is an explanatory view illustrating the suction force of a bonding step of the present embodiment.

FIG. 5 is an explanatory view schematically illustrating a shutter device as a comparative example.

FIG. 6 is an explanatory view illustrating the suction force of a bonding step of another embodiment of the present invention.

FIG. 7 is an explanatory view illustrating the suction force of a bonding step of another embodiment of the present invention.

FIG. 8 is an explanatory view illustrating the suction force of a bonding step of another embodiment of the present invention.

### DESCRIPTION OF EMBODIMENTS

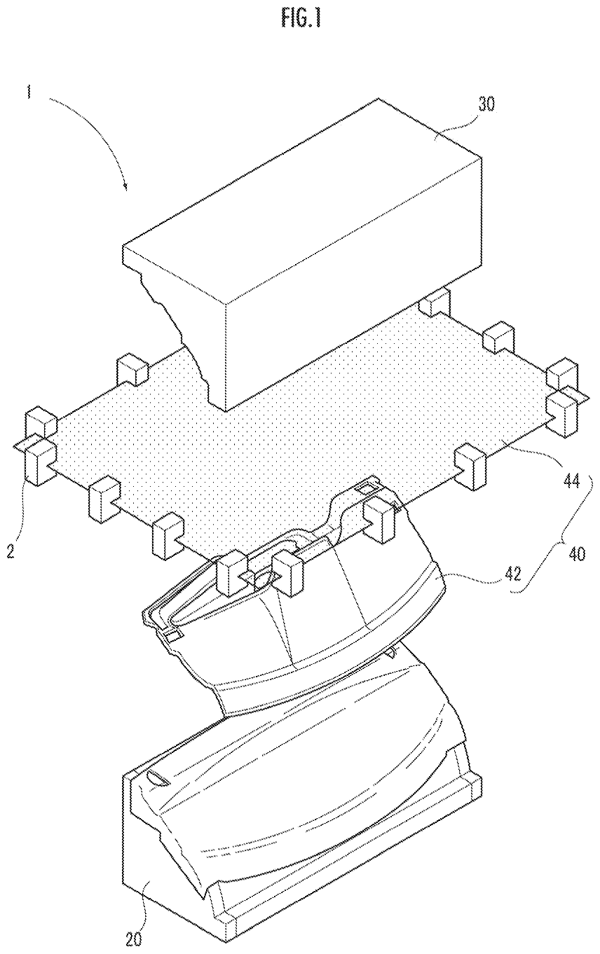

Embodiments of the stacked workpiece molding device and the stacked workpiece molding method of the present invention will be described with reference to the drawings. Referring to FIG. 1, a stacked workpiece molding device 1 of the present embodiment includes a first mold 20 and a second mold 30. A stacked workpiece 40 such as an instrument panel molded by the stacked workpiece molding device 1 includes a workpiece body 42 and a sheet material 44 stacked on the workpiece body 42.

The stacked workpiece molding device 1 includes a plurality of clamps 2 for gripping the peripheral edge of the sheet material 44.

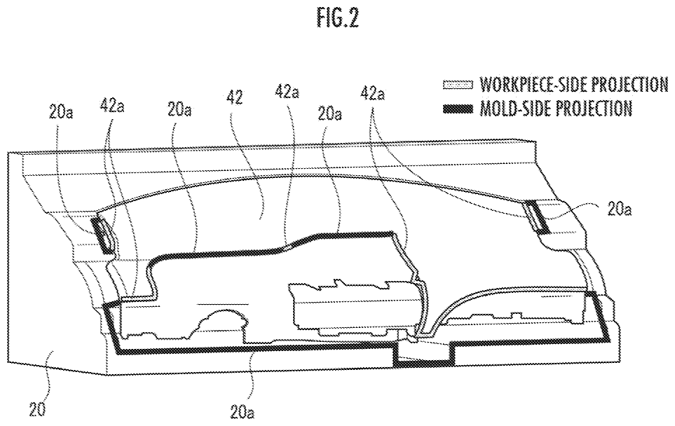

FIG. 2 illustrates a state in which the workpiece body 42 is placed on the first mold 20.

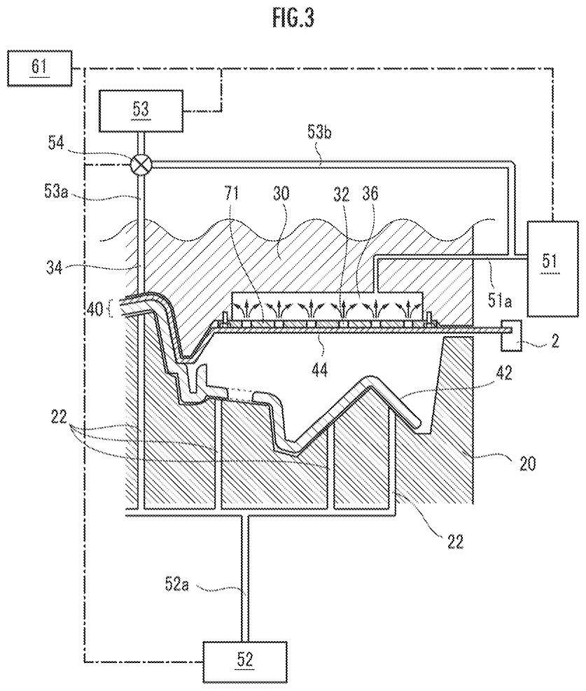

As illustrated in FIG. 3, the first mold 20 includes a plurality of suction holes 22 opened to a placement surface on which the workpiece body 42 is placed. On the inner surface of the second mold 30, a pattern such as embossing or satin to be transferred to the surface of the sheet material 44 is formed.

The second mold 30 includes a plurality of through-holes 32 extending to be opened at the position of the peripheral edge of the workpiece body 42 when the second mold 30 is overlapped with the first mold 20 across the workpiece body 42 and the sheet material 44. The through-holes 32 of the present embodiment are formed of holes bored in a plate 71 that is provided to cover the opening of a recess 36 formed on the inner surface of the second mold 30. Note that the through-holes 32 are not limited to the bores of the plate 71, but the through-holes of the present invention may be formed by, for example, pores of a porous member embedded in the recess 36.

Further, the second mold 30 includes a plurality of ejection holes 34 extending to be opened at the position of a central portion of the workpiece body 42, which is a part excluding the peripheral edge of the workpiece body 42.

The through-holes 32 are connected to a first suction device 51 for sucking the sheet material 44 via a first connection pipe 51a. The suction holes 22 are connected to a second suction device 52 for sucking the workpiece body 42 via a second connection pipe 52a. The ejection holes 34 are connected to a gas supply device 53 for supplying a gas such as air via a third connection pipe 53a.

The first connection pipe 51a and the third connection pipe 53a are connected to a bypass path 53b. A connection portion between the third connection pipe 53a and the bypass path 53b includes a flow path switching valve 54. The flow path switching valve 54 is configured to be switchable between two states: an “ejectable state” in which the gas supply device 53 is connected to the ejection holes 34 via the third connection pipe 53a and the connection of the ejection holes 34 to the first suction device 51 via the bypass path 53b is disconnected; and a “suckable state” in which the first suction device 51 is connected to the ejection holes 34 via the third connection pipe 53a, the bypass path 53b, and the first connection pipe 51a and the connection between the ejection holes 34 and the gas supply device 53 is disconnected.

Further, referring to FIG. 2, the first mold 20 and the workpiece body 42 include respectively a mold-side projection 20a and a workpiece-side projection 42a projecting toward the second mold 30 and extending along the outer edge of a bonding region of the sheet material 44 so as to surround the plurality of through-holes 32.

Here, assuming that the mold-side projection 20a and the workpiece-side projection 42a are not provided, when the sheet material 44 is separated from the second mold 30 by supplying the gas to the surface of the sheet material 44 from the gas supply device 53 through the ejection holes 34 in the bonding step of bonding the sheet material 44 to the workpiece body 42, when the gas supplied to the surface of the sheet material 44 flows directly into the through-holes 32 and is sucked by the first suction device 51, the sheet material 44 suction performance by the first suction device 51 deteriorates.

Therefore, in the present embodiment, as described above, when the mold-side projection 20a and the workpiece-side projection 42a are provided so as to surround the through-holes 32, it is possible to suppress or prevent the gas supplied from the gas supply device 53 to the surface of the sheet material 44 from flowing into the through-holes 32, and it is possible to suppress or prevent the deterioration of the sheet material 44 suction performance by the first suction device 51. Note that, instead of the mold-side projection 20a and the workpiece-side projection 42a, the mold-side projection may be provided on the second mold 30.

The stacked workpiece molding device 1 includes a control unit 61 that controls the first suction device 51, the second suction device 52, the gas supply device 53, and the flow path switching valve 54. The control unit 61 is an electronic control unit including a CPU, a memory, and the like, and controls the first suction device 51, the second suction device 52, the gas supply device 53, and the flow path switching valve 54 by executing a control program held in a storage unit such as the memory by using the CPU and transmitting an instruction signal.

Next, the stacked workpiece molding method using the stacked workpiece molding device 1 will be described.

First, the first mold 20 and the second mold 30 are brought into an open state, and the workpiece body 42 is placed on the first mold 20. Then, the sheet material 44 gripped by the clamps 2 is arranged between the workpiece body 42 and the second mold 30. Then, the first mold 20 and the second mold 30 are brought closer to each other into a closed state.

Next, the control unit 61 switches the flow path switching valve 54 to the “suckable state” (the state in which the first suction device 51 is connected to the ejection holes 34 via the third connection pipe 53a, the bypass path 53b, and the first connection pipe 51a and the connection between the ejection holes 34 and the gas supply device 53 is disconnected) so that the sheet material 44 is sucked by the first suction device 51 and stuck to the inner surface of the second mold 30 via the through-holes 32 and the ejection holes 34. Thus, the pattern formed on the inner surface of the second mold 30 can be transferred to the surface of the sheet material 44 (transfer step).

Next, in a state where an adhesive is applied to the workpiece body 42 or the sheet material 44, the sheet material 44 is pressed against the workpiece body 42 and bonded by the suction force of the second suction device 52 (bonding step).

Here, the sheet material 44 is not bonded to the entire surface of the workpiece body 42, but is bonded only to a portion exposed when an automobile or the like is assembled, and unbonded to a portion such as the peripheral edge hidden by other components during assembly to prevent assembly failure, and only the bonded portion is left and the non-bonded portion is cut and discarded.

Then, in the bonding step, the control unit 61 switches the flow path switching valve 54 to the “ejectable state” (the state in which the gas supply device 53 is connected to the ejection holes 34 via the third connection pipe 53a and the connection of the ejection holes 34 to the first suction device 51 via the bypass path 53b is disconnected) so that the gas supply device 53 supplies the gas through the ejection holes 34 between the sheet material 44 and the second mold 30 to separate the sheet material 44 from the second mold 30.

Further, the control unit 61 causes the first suction device 51 to suck the portion of the sheet material 44, which is not bonded to the workpiece body 42, via the through-holes 32 to the second mold 30.

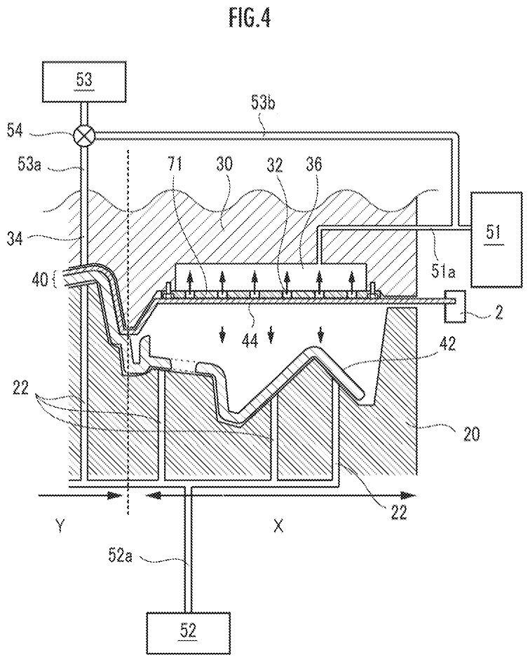

At this time, as indicated by non-bonding region X in FIG. 4, the control unit 61 sets the suction forces of the first suction device 51 and the second suction device 52 so that the suction force for sucking the sheet material 44 through the through-holes 32 becomes stronger than the suction force for sucking the workpiece body 42 through the suction holes 22. By setting the suction forces in this manner, the sheet material 44 of the unbonded portion can be appropriately drawn to the second mold 30.

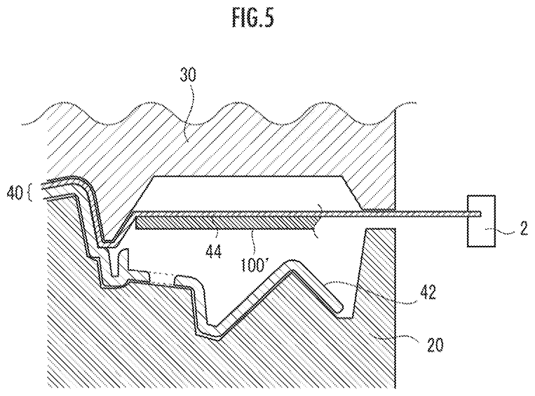

As described above, since the unbonded portion positioned at the peripheral edge of the workpiece body 42 is sucked by the first suction device 51 through the through-holes 32, as illustrated in FIG. 5 as a comparative example, it is not necessary to provide a shutter device 100′ for preventing bonding of the sheet material 44 at the peripheral edge of the workpiece body 42. Therefore, it is not necessary to arrange the clamps outside the shutter device 100′ so as to avoid the shutter device 100′ or prepare a wide sheet material 44, and the amount of the waste part of the sheet material 44 can be reduced and the manufacturing cost for the stacked workpiece 40 can be suppressed.

Further, assuming that the mold-side projection 20a and the workpiece-side projection 42a are not provided, when the sheet material 44 is separated from the second mold 30 by supplying the gas to the surface of the sheet material 44 from the gas supply device 53 through the ejection holes 34 in the bonding step of bonding the sheet material 44 to the workpiece body 42, when the gas supplied to the surface of the sheet material 44 flows directly into the through-holes 32 and is sucked by the first suction device 51, the sheet material 44 suction performance by the first suction device 51 deteriorates.

Therefore, in the present embodiment, as described above, when the mold-side projection 20a and the workpiece-side projection 42a are provided so as to surround the through-holes 32, it is possible to suppress or prevent the gas supplied from the gas supply device 53 to the surface of the sheet material 44 from flowing into the through-holes 32, and it is possible to suppress or prevent the deterioration of the sheet material 44 suction performance by the first suction device 51. Note that, instead of the mold-side projection 20a and the workpiece-side projection 42a, the mold-side projection may be provided on the second mold 30.

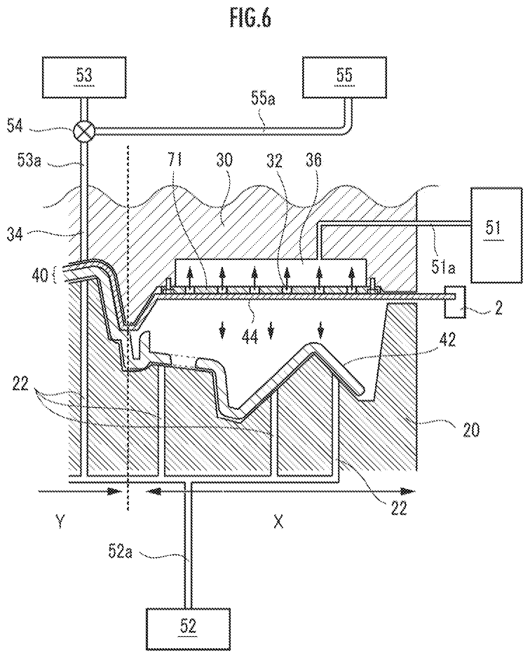

Further, the present embodiment describes that the bypass path 53b for bypassing the first connection pipe 51a and the third connection pipe 53a is provided, and the flow path switching valve 54 is provided at the connection portion between the third connection pipe 53a and the bypass path 53b, but the present invention is not limited to this, but may be configured as indicated, for example, as other embodiments in FIGS. 6 to 8.

In FIG. 6, instead of the bypass path 53b, a fourth connection pipe 55a is connected to the flow path switching valve 54, and a third suction device 55 is connected to the fourth connection pipe 55a.

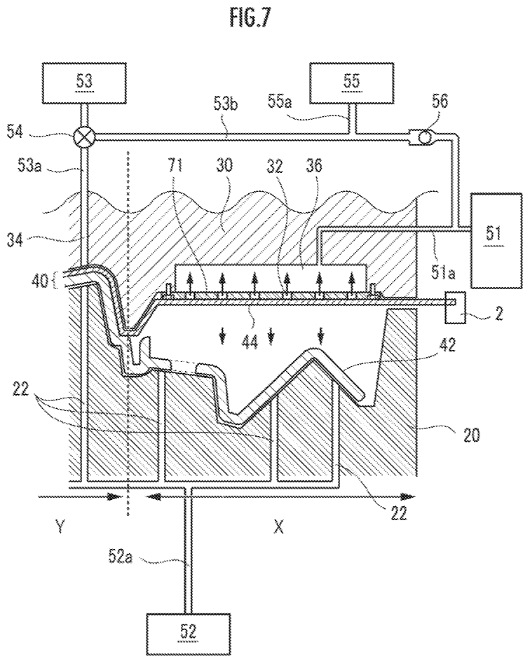

In FIG. 7, the third suction device 55 is connected to the bypass path 53b via the fourth connection pipe 55a, and a check valve 56 is provided to be positioned between the fourth connection pipe 55a and the first connection pipe 51a in the bypass path 53b to prevent the gas from flowing from the third connection pipe 53a side to the first connection pipe 51a side.

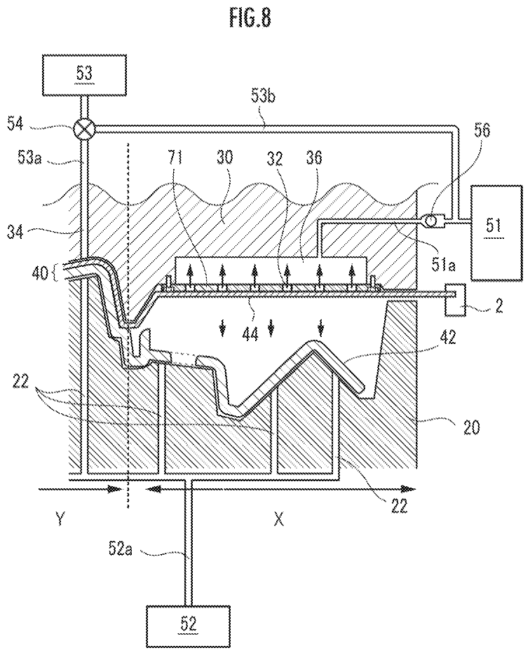

In FIG. 8, in the first connection pipe 51a, the check valve 56 is provided to be positioned between the portion where the through-holes 32 are connected to the bypass path 53b to prevent the gas from flowing from the bypass path 53b to the through-holes 32.

### REFERENCE SIGNS LIST

1 stacked workpiece molding device

2 clamp

20 first mold

20a mold-side projection

22 suction hole

30 second mold

32 through-hole

34 ejection hole

36 recess

40 stacked workpiece

42 workpiece body

42a workpiece-side projection

44 sheet material

51 first suction device

51a first connection pipe

52 second suction device

52a second connection pipe

53 gas supply device

53a third connection pipe

53b bypass path

54 flow path switching valve

55 third suction device

55a fourth connection pipe

56 check valve

61 control unit

71 plate

100′ shutter device

X non-bonding region

Y bonding region

1. A stacked workpiece molding method for molding a stacked workpiece by bonding a sheet material to a workpiece body using a stacked workpiece molding device including:
a first mold configured to suck and hold the workpiece body; and
a second mold configured to have on an inner surface a pattern that can be transferred to a surface of the sheet material stacked on the workpiece body and press the sheet material against the workpiece body;
the method comprising:
a transfer step of causing the sheet material to be stuck to the second mold and transferring the pattern onto the sheet material, wherein
the second mold includes a through-hole that extends to be opened and positioned at a peripheral edge of the workpiece body,
the through-hole is connected to a first suction device that sucks the sheet material,
the first mold includes a suction hole that extends to be opened at a portion that contacts the workpiece body,
the suction hole is connected to a second suction device that sucks the workpiece body, and
in a bonding step of bonding the sheet material to the workpiece body, a suction force in the through-hole by the first suction device is set stronger than a suction force in the suction hole by the second suction device.

2. The stacked workpiece molding method according to claim 1, wherein
the second mold includes an ejection hole that extends to be positioned at a central portion of the workpiece body,
the ejection hole is connected to a gas supply device that supplies a gas to detach the sheet material from the inner surface of the second mold,
one mold of the first mold and the second mold includes a mold-side projection that projects toward the other mold so as to surround the through-hole, and
in the bonding step of bonding the sheet material to the workpiece body, the gas is supplied from the gas supply device to the surface of the sheet material through the ejection hole to separate the sheet material from the second mold at the central portion of the workpiece body.

3. The stacked workpiece molding method according to claim 2, wherein the mold-side projection is provided on the first mold.

4. A stacked workpiece molding device comprising:
a first mold configured to suck and hold a workpiece body; and
a second mold configured to have on an inner surface a pattern that can be transferred to a surface of a sheet material stacked on the workpiece body and press the sheet material against the workpiece body, wherein
the second mold includes a through-hole that extends to be opened and positioned at a peripheral edge of the workpiece body,
the through-hole is connected to a first suction device that sucks the sheet material,
the first mold includes a suction hole for sucking the workpiece body,
the suction hole is connected to a second suction device, and
the stacked workpiece molding device includes a control unit that sets suction forces of the first suction device and the second suction device.

5. The stacked workpiece molding device according to claim 4, wherein the control unit sets the suction force in the through-hole by the first suction device to be stronger than the suction force in the suction hole by the second suction device in a bonding step of bonding the sheet material to the workpiece body.

6. The stacked workpiece molding device according to claim 4, wherein
the second mold includes an ejection hole that extends to be positioned at a central portion of the workpiece body,
the ejection hole is connected to a gas supply device that supplies gas to detach the sheet material from the inner surface of the second mold,
one mold of the first mold and the second mold includes a mold-side projection that projects toward the other mold so as to surround the through-hole, and
the control unit, in a bonding step of bonding the sheet material to the workpiece body, supplies the gas from the gas supply device to the surface of the sheet material through the ejection hole to separate the sheet material from the second mold at the central portion of the workpiece body.

7. The stacked workpiece molding device according to claim 5, wherein
the second mold includes an ejection hole that extends to be positioned at a central portion of the workpiece body,
the ejection hole is connected to a gas supply device that supplies gas to detach the sheet material from the inner surface of the second mold,
one mold of the first mold and the second mold includes a mold-side projection that projects toward the other mold so as to surround the through-hole, and
the control unit, in the bonding step of bonding the sheet material to the workpiece body, supplies the gas from the gas supply device to the surface of the sheet material through the ejection hole to separate the sheet material from the second mold at the central portion of the workpiece body.

8. The stacked workpiece molding device according to claim 6, wherein the mold-side projection is provided on the first mold.

9. The stacked workpiece molding device according to claim 7, wherein the mold-side projection is provided on the first mold.
